(19) United States
(12) Patent Application Publication
(10) Pub. No.: US 2025/0033493 A1
(43) Pub. Date: Jan. 30, 2025

(54) MULTI-OUTPUT BATTERY ELECTRIC VEHICLE CHARGER WITH SWITCHED MODE POWER SUPPLY

(71) Applicant: BorgWarner Inc., Aubum Hills, MI (US)

(72) Inventors: Luca Di Carlo, Royal Oak, MI (US); Brian C. Wightman, Davisburg, MI (US)

(21) Appl. No.: 18/226,337

(22) Filed: Jul. 26, 2023

(51) Int. Cl. B60L 53/16; H02J 7/04

(52) U.S. Cl. CPC B60L 53/16; H02J 7/04

(57) ABSTRACT

A battery electric vehicle (BEV) charging station includes at least one power module having a plurality of switches that rectify alternating current (AC) electrical power received from a power grid into direct current (DC) electrical power supplied to a BEV; at least one switched mode power supply (SMPS) internal to the power module; and operational equipment electrically connected to the SMPS in the power control module.

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates to battery electric vehicles (BEVs) and, more particularly, to charging stations used to charge BEVs.

### BACKGROUND

Battery electric vehicles (BEVs) are increasingly used by consumers for their transportation needs. The BEVs include one or more electric motors, a vehicle battery, and power electronics that regulate the supply of electrical power from the vehicle battery to the electric motor(s). As the number of BEVs increase, so too will the number of BEV charging stations available to recharge vehicle batteries of the BEVs. The BEV charging stations can include multiple charging cables/plugs each available to provide charge to a BEV. However, BEV charging stations having more than one charging cable can also involve more hardware to implement such a system. For example, the BEV charging station can include a graphical user interface (GUI) for controlling each charging cable, a cooling system to ensure the BEV charging station operates at an optimal temperature, as well as other systems. It would be helpful to arrange electrical components within the BEV charging station to efficiently charge BEVs coupled to the station as well as minimize the number of electrical components.

### SUMMARY

In one implementation, a battery electric vehicle (BEV) charging station includes at least one power module having a plurality of switches that rectify alternating current (AC) electrical power received from a power grid into direct current (DC) electrical power supplied to a BEV; at least one switched mode power supply (SMPS) internal to the power module; and operational equipment electrically connected to the SMPS in the power control module.

### BRIEF DESCRIPTION OF THE DRAWINGS

FIG. 1 is a block diagram depicting an implementation of an electrical system including a BEV charger; and

FIG. 2 is a block diagram depicting an implementation of a BEV charger.

### DETAILED DESCRIPTION

A BEV charging station can include a plurality of power modules each able to electrically connect to a BEV to provide electrical charge. The power modules can include a variety of electrical components that rectify alternating current (AC) electrical power received from the power grid into direct current (DC) electrical power supplied to the BEV. In addition, the power modules can each include a switched mode power supply (SMPS). The plurality of power modules can be electrically connected in parallel to the power grid through an electromagnetic interference (EMI) filter. The BEV charging station can include other operational hardware used to implement the station. For example, the operational hardware can include a GUI used by a vehicle operator to control charging the BEV. Or, in another example, the operational hardware can include a cooling system, such as a fan, that cools the plurality of power modules included at the BEV charging station. Or the operational hardware can include external lighting, to name a few examples.

The electrical power provided to the BEVs can be different from what is provided to the operational hardware of the BEV charger. For instance, the BEV charger can provide DC voltage to a BEV at a level between 100-1000V. However, the electrical voltage used by the operational hardware may be a different voltage, it may be AC voltage, or DC voltage. In the past, each unit of operational hardware may have been electrically connected to the grid via a dedicated SMPS. The SMPS can supply and regulate electrical power to the operational hardware, that may include logic circuits, gate drivers, or analog circuits. For instance, if the BEV charger includes a graphical user interface (GUI) for the user to enter control inputs to control the charger, the GUI would be electrically connected to the power grid via a dedicated SMPS. And if the BEV charger also included a cooling system, the system would be linked to the power grid via a separate and dedicated SMPS. In this system, the power modules are electrically isolated from the SMPS and the operational hardware. Given that BEV chargers may be installed in demanding environments such that they are designed for an overvoltage category 3 and pollution degree 3, an SMPS that meets these criteria and is also linked to the grid can be expensive. In contrast, the present application involves power modules that can each include an internal SMPS with an output port that may supply electrical power to operational hardware within the BEV. The output port can be implemented using a low-voltage rail.

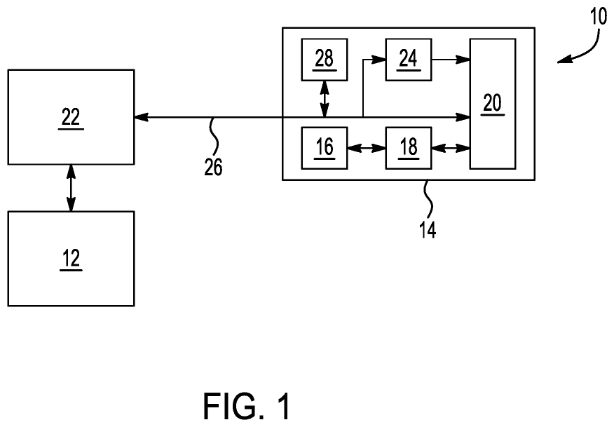

Turning to FIG. 1, an implementation of an electrical system 10 is shown including an electrical grid 12 and an electric vehicle (BEV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated over relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase, 50-60 hz. However, this voltage range can be different.

The BEV 14 can include an electric motor 16 that wholly, or at least partially, propels the vehicle. In the described implementation, the electric motor 16 is an interior permanent magnet synchronous motor (IPMSM), but other implementations are possible using the controller and functionality described herein. A three-phase inverter 18 can be electrically coupled to a BEV battery 20 and the electric motor 16. The inverter 18 can receive DC electrical power from 10 the BEV battery 20 and invert the DC electrical power into three-phase AC electrical power before supplying the AC electrical power to the electric motor 16. The amount of voltage supplied by the BEV battery 20 to the electric motor 16 can vary by application. The term “electric vehicle” or “BEV” can refer to vehicles that are propelled, either wholly or partially, by electric motors. BEV can refer to electric vehicles, plug-in electric vehicles, hybrid-electric vehicles, and battery-powered vehicles.

A BEV charging station 22 can receive AC electrical power from the grid 12, rectify the AC electrical voltage into DC electrical power, and provide the DC electrical power to the BEV 14. The BEV charging station 22 can be geographically fixed, such as a charging station located in a vehicle garage or in a vehicle parking lot. The BEV charging station 22 can include an input terminal that receives the AC electrical power from the grid 12 and communicates the AC electrical power to the BEV battery 20 directly, bypassing an on-board vehicle battery charger 24 included on the BEV 14. An electrical cable 26 can detachably connect with an electrical receptacle on the BEV 14 and electrically link the BEV charging station 22 with the BEV 14 so that DC electrical power can be communicated between the BEV charging station 22 and the BEV battery 20. One type of DC fast charging may be referred to as Level 3 BEV charging, considered to be 60-350 kW. However, other charging standards and power levels are possible with the structure and functionality disclosed here. The BEV battery 20 can supply DC electrical power controlled by power electronics to the electric motor 16 that propels the BEV 14. The BEV battery 20 or batteries are rechargeable. Examples of the battery include lead acid batteries, nickel cadmium (NiCd), nickel metal hydride, lithium-ion, and lithium polymer batteries. However, battery technology is evolving and other chemistries and/or voltages may be used. A typical range of vehicle battery voltages can range from 100 to 1000V of DC electrical power (VDC). A control system 28 implemented as computer-readable instructions executable by the microprocessor, can be stored in non-volatile memory and called on to monitor vehicle sensors and generate control signals that include a torque command for the electric motor 16 of the BEV 14. This will be discussed in more detail below.

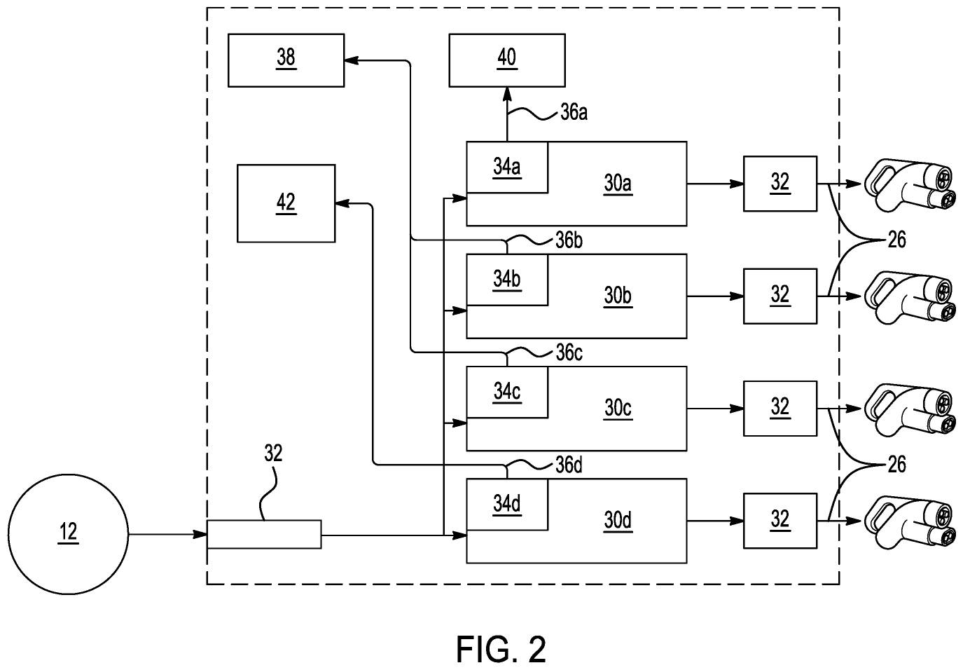

An implementation of the BEV charging station 22 is shown in FIG. 2. The BEV charging station 22 includes a plurality of power modules 30 each capable of providing electrical charge to a BEV. The power modules 30 can include a plurality of switches and a transformer configured to rectify AC electrical power into DC electrical power. The switches can be implemented using MOSFETs or other similar switching device. Control of the power modules 30 as well as the other BEV charging station hardware can be carried out by the control system 28. Each power module 30 can include an input that is electrically connected to the electrical grid 12. The three-phase AC electrical power provided by the grid 12 can be passed through an electrical magnetic interference (EMI) filter 32 before arriving at the power module 30. The power module 30 can include a charging output that is electrically connected to the electrical cable 26 that detachably connects to the BEV 14. The power modules 30 can provide the BEV 14 DC electrical power though the electrical cable 26. The DC electrical power can first pass through an EMI filter 32 before reaching the BEV 14.

The power modules 30 can also each include an internal SMPS 34 having an output port 36 that can be electrically connected to other operational hardware in the BEV charging station 22. In this implementation, the BEV charging station 22 can include operational hardware such as a cooling system 38, an HMI 40, and other ancillary systems 42. The cooling system 38 can include one or more fans that circulate air over the power modules 30 to reduce their temperature during operation. The HMI 40 can include a touchscreen that displays control options to a user who can select different charging functions based on these options. For example, the user can indicate which electrical cable is connected to the user's vehicle and begin charging the BEV.

The output voltage from the SMPS 34 can be programmed to exist at a level compatible with the operational hardware the SMPS 34 supplies with power. Implementations in which the output voltage is 6 V, 12V, or 24V are possible. For example, the SMPS 34a included in a first power module 30a can be electrically connected via the output port 36a to the HMI 40. The power module 30a can be programmed so that the SMPS 34 provides an output voltage of 12V. Power modules 30b-30c can each have an SMPS 34b-34c that is electrically connected via the output ports 36b-36c to the cooling system 38. The SMPS 34b-34c in power modules 30b-30c can be programmed to output 24V. Or more particularly, the SMPS 34b-34c in power modules 30b-30c can each be programmed to output 12V and are electrically combined to collectively provide 24V. And the SMPS 34d included in power module 30d can be electrically connected via the output port 36d to the HMI 40. The power module 30d can be programmed so that the SMPS 34d provides an output voltage of 12V. The SMPS 34 can compensate for over voltage and over current events. And the SMPS 34 can be electrically configured so that it is electrically isolated or non-isolated.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A battery electric vehicle (BEV) charging station, comprising:
at least one power module having a plurality of switches that rectify alternating current (AC) electrical power received from a power grid into direct current (DC) electrical power supplied to a BEV;
at least one switched mode power supply (SMPS) internal to the power module; and
operational equipment electrically connected to the SMPS in the power control module.

2. The BEV charging station recited in claim 1, further comprising a plurality of power modules and a plurality of SMPSs.

3. The BEV charging station recited in claim 1, wherein the SMPS outputs an electrical voltage level that is programmable.

4. The BEV charging station recited in claim 1, wherein the operational equipment includes a graphical user interface (GUI), a cooling system, or external lights.

5. The BEV charging station recited in claim 1, further comprising an electromagnetic (EMI) filter electrically linked to the power module and configured to electrically connect with the power grid.

6. The BEV charging station recited in claim 1, further comprising an electromagnetic (EMI) filter electrically linked to the power module and configured to electrically connect with the BEV.

7. The BEV charging station recited in claim 1, wherein the SMPS is non-isolated.

8. The BEV charging station recited in claim 1, wherein the switches are MOSFETs.
